(19) United States
(12) Patent Application Publication
(10) Pub. No.: US 2011/0028044 A1
(43) Pub. Date: Feb. 3, 2011

(54) FLAT PIN OF NETWORK JACK AND METHOD FOR GILDING THE SAME

(76) Inventors: JOHN PENG, Shen Keng Shiang (TW); Allen Lee, Shen Keng Shiang (TW)

Correspondence Address: Allen, Dyer, Doppelt, Milbrath & Gilchrist, P.A.;Suite 1401, 255 South Orange Avenue, P.O. Box 3791, Orlando, FL, 32801, US

(21) Appl. No.: 12/631,024

(22) Filed: Dec. 4, 2009

(30) Foreign Application Priority Data
Jul. 29, 2009 (TW) 098125596

(51) Int. Cl. H01R 33/00; H01R 13/02

(52) U.S. Cl. 439/660; 439/884

(57) ABSTRACT

A flat pin of a network jack and a method for gilding the same are provided. A body of the flat pin has a single surface which has a front end and a back end in the gilding method. The method includes the steps of gilding a metal layer on the front end, and electroplating continuously from the front end to the back end on the single surface at all times. The single surface is fully covered by the metal layer.

### TECHNICAL FIELD

The present disclosure relates to a flat pin of a network jack and a method for gilding the same, and more particularly to a flat pin of a network jack that the single surface of the flat pin is fully covered by the metal layer and a method for gilding the same.

### BACKGROUND

A general keystone jack for the network communication has a jack body, and there are 8 contact pins mounted inside the jack body (the contact pin is a metal wire whose surface is plated with a layer of 50 microinch of gold over nickel), for connecting 8 golden lock bits mounted on the network plug. The contact pins are usually made of two forms which are a round pin having a sectional area of 0.166190251 mm² and a flat pin having a sectional area of 0.12 mm², whose gilding patterns are not the same. Referring to FIG. 1, there is shown a section of a material tape of round pin 10, and the process steps for gilding round pin 10 are as follows:
1. So far conventional round pin 10 is made by the method of the drawing wire, whose material received pattern is to coil round pin 10 on a spool 20 (whose material is plastic or paper) as shown in FIG. 2, and drawn round pin 10 is the material of phosphor bronze.
2. The material tape of the coiled round pin 10 then is electroplated. When the electroplating process is finished, it is coiled again for preparing the delivery.

As regards the advantages and drawbacks of round pin 10, they are analyzed as follows:
Advantage A: There is no scrap generated during the fabricating process. As it uses the means of the drawing wire, it doesn't have any scrap during the fabricating process.
Advantage B: Forasmuch round pin 10 has no directionality, it is convenient for the design of the automatic production upon producing.
Drawback A: Forasmuch the persisting soaring of international gold price, by comparing the plating pattern of round pin 10 having a diameter D of 0.46 mm and that of the used girth of the flat pin, a length of 1.445132621 mm of a whole plating circumference 30 is compared with a single side girth of 0.4 mm (i.e. the gilding amount ratio of round pin 10 to the flat pin, is approximately 3.6 to 1). Thus, it is known why the cost of a gilding layer 31 of round pin 10 is more expensive; and
Drawback B: The mass production cannot be made on round pin 10 as the selected plating pattern on the flat pin.

Referring to FIG. 4, there is shown a material tape 40, a selecting plating range SR, and a first and a second non-contacting areas 421, 422. Material tape 40 has plural fat pins 41, the head and tail of each flat pin 41 are independent with each other, and thus this is different from round pin 10 whose head and tail are continuously connected with each other before cutting. Because the problem of the higher gilding cost of round pin 10 should be overcome, it can take flat pin 41 having the selecting plating property, which has 0.4 mm (or 0.45 mm) of a width W and 0.3 mm of a thickness T of the cross section as shown in FIG. 5, and the process steps for gilding a single surface 50 of flat pin 41 are illustrated as follows:
1. So far conventional flat pin 41 is pressed to the shape by the press and the mold, for making material tape 40 of flat pin 41 (there is no drawing-wire method for making flat pin 41 at present).
2. Then coiled material tape 40 of flat pin 41 was electroplated. When the plating process is finished, plated material tape 40 is coiled again for delivery.

As regards the advantages and drawbacks of flat pin 41, they are analyzed as follows:
Advantage A: Because of the persisting soaring of international gold price, the comparison between the used girth of round pin 10 with that of flat pin 41 having 0.4 mm of width W and 0.3 mm of thickness T is 0.4 mm to 1.445132621 mm (i.e. the gilding amount ratio of flat pin 41 to round pin 10 is approximately 1 to 3.6), then we can know the cheaper gilding cost of flat pin 41.
Advantage B: In addition to the whole plating technique of round pin 10, a selecting plating range SR of a top surface 50 also can be set on flat pin 41. The area (i.e. connecting area) which is contacted to a network plug (not shown in figure) is selected to be gilded, then it can reduce the employed plating material of a bottom surface 51, a front-side surface 52, a back-side surface 53, a first and a second non-contacting area 421, 422, and the gilding cost can be dramatically reduced.
Drawback A: Forasmuch material tape 40 is necessary for towing flat pin 41, but material tape 40 actually is not necessary after the processing, the scrap would be formed. In the area of 1 unit, approximately the scrap of 0.6 unit would be generated;
Drawback B: In comparison of the cost of the press of flat pin 41 with that of the drawing wire of round pin 10 from their fabrication processes, the cost of the press fabrication process is awfully larger than that of the drawing wire.
Drawback C: Forasmuch one single flat pin 41 has the directionality, if the only one flat pin is gilded rather than whole row of flat pin 41 on material tape 40 being gilded, the control of direction would be a great challenge at the automatic production. Because flat pin has the sectional area of 0.4 mm×0.3 mm to be as a square, the directionality is generated when single surface 50 of the plat pin is only plated. Thus, the question of overturning to be overcome would be a great challenge.

Therefore, how to improve the problems of the extremely high gilding cost for the round pin and too much scrap for the flat pin are solved in the present invention. The inventors endeavor in the experiments, tests and researches to obtain a flat pin of a network and method for gilding the same, which not only resolve the drawback of the high gilding cost for the conventional round pin, but also achieves the convenience that no further scrap of the flat pin is generated. Namely, the subject matters to be resolved in the present invention are how to overcome the problem that the scrap ratio per unit area is too high for the flat pin, and consequently the gilding pattern of more economizing material of a continuous material tape is feasible, how to overcome the problem that the plating is performed only for the single surface of the flat pin of the continuous material tape, and how to overcome the problem that the movement of the continuous flat pin is not sufficiently stable in the positioning fixture.

### SUMMARY

The present invention relates to a method for plating a flat pin of a connecting device, the flat pin having four edges and a specific surface, includes a step of continuously plating a conductive layer all over the specific surface of the flat pin, wherein the specific surface is surrounded by the four edges of the flat pin.

Preferably, the method further includes a step of scrolling the plated flat pin by a spool.

Preferably, the method further includes a step of positioning the flat pin with a positioning fixture.

Certainly, the method can further include a step of pulling the flat pin positioned within the positioning fixture for continuously plating the conductive layer on the specific surface.

Certainly, the positioning fixture of the method can have a first, a second and a third supporting surfaces, the flat pin further includes a left-side, a bottom and a right-side surfaces, and the step of positioning the flat pin is performed via urging against the left-side, the bottom and the right-side surfaces by the first, the second and the third supporting surfaces respectively.

Preferably, the specific surface of the method has a front and a back ends being two opposite ones of the four edges respectively, and the step of continuously plating the conductive layer continuously plates the conductive layer on the specific surface from the frond end to the back end for totally covering the specific surface.

Preferably, the conductive layer of the method has a material of a gold, and the connecting device is a network jack.

According to one outlook of the main technique, the present invention can cover a flat pin of a network jack, which includes a pin body having four edges defining a specific surface thereamong, and configured in a connecting device, and a conductive layer totally covering the specific surface.

Certainly, the pin body of the flat pin can include six surfaces, the specific surface is a top one of the six surfaces of the pin body, and the connecting device is a network jack.

Certainly, the six surfaces can be respectively the top surface, a bottom surface, a front-side surface, a back-side surface, a left-side surface and a right-side surface.

Preferably, the flat pin includes six surfaces, and the specific surface is a bottom one of the six surfaces of the pin body.

Preferably, the specific surface of the flat pin has a contacting area, and a first and a second non-contacting areas.

Certainly, the contacting area of the flat pin can contact an external network plug.

Certainly, the four edges of the flat pin can be four straight edges.

According to another feasible point of view, the present invention is a network jack, which includes a flat pin including four edges surrounding a specific surface therein, and a conductive layer totally covering the specific surface.

Preferably, the flat pin of the jack has six surfaces of a top surface, a bottom surface, a front-side surface, a back-side surface, a left-side surface and a right-side surface.

Preferably, the specific surface of the jack is the top surface.

Certainly, the specific surface of the jack can be the bottom surface.

Certainly, the specific surface of the jack can have a contacting area, and a first and a second non-contacting areas, and the contacting area contacts a network plug.

Preferably, the jack further includes a jack body, the flat pin of the jack is configured in the jack body.

By way of the above-mentioned explication of the concept, it can be known the manipulation of the flat pin of a network jack and the method for gilding the same, which can utilize the plating a metal layer on the front end, and the continuously plating from the front end to the back end all the time on the single surface, and the feature of utilizing a positioning fixture to gild on the single surface of the flat pin for avoiding the plating on the left side surface and the right side surface. For the easier illustration, the present invention will become more ready comprehension by the following-mentioned preferred embodiments and the drawings.

### BRIEF DESCRIPTION OF THE DRAWINGS

FIG. 1 is a schematic diagram of the cross-section of the material tape of the prior round pin wire according to the prior art;

FIG. 2 is a perspective schematic diagram of the plastic spool utilized by the round pin in FIG. 1;

FIG. 3 is a side view schematic diagram of the whole plating circumference of the round pin in FIG. 1;

FIG. 4 is a top view schematic diagram of the of the material tape of the whole row flat pin according to the prior art;

FIG. 5 is a schematic diagram of the cross-section of the flat pin in FIG. 4;

FIG. 6 is a top view schematic diagram of the preferred embodiment of the material tape having the single flat pin of the network jack according to the present disclosure;

FIG. 7 is a side view schematic diagram of the positioning fixture for the utilization of the flat pin in FIG. 6;

FIG. 8 is a perspective schematic diagram of the flat pin cut from the material tape in FIG. 6;

FIG. 9 is a profile schematic diagram of the combination of the flat pin in FIG. 8 with the positioning fixture in FIG. 7; and

FIG. 10 is a schematic diagram of the cross-section of the flat pin in FIG. 8.

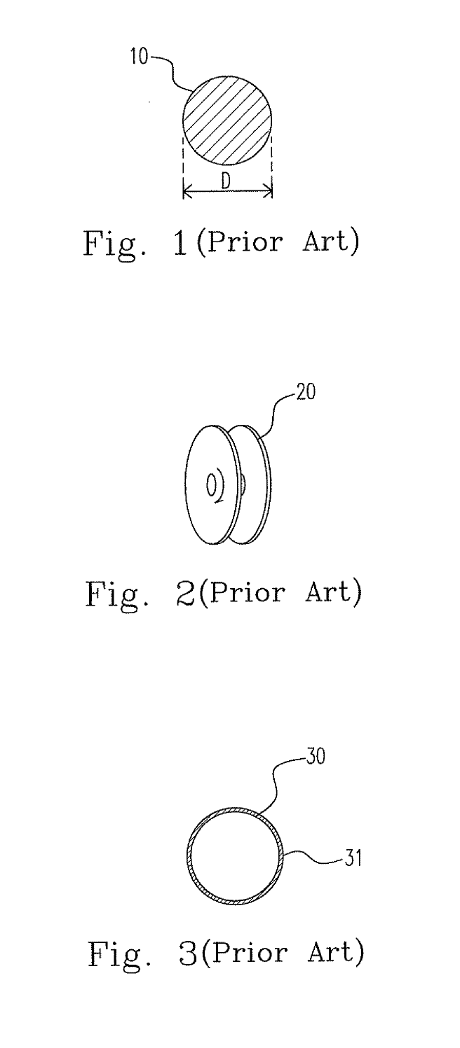

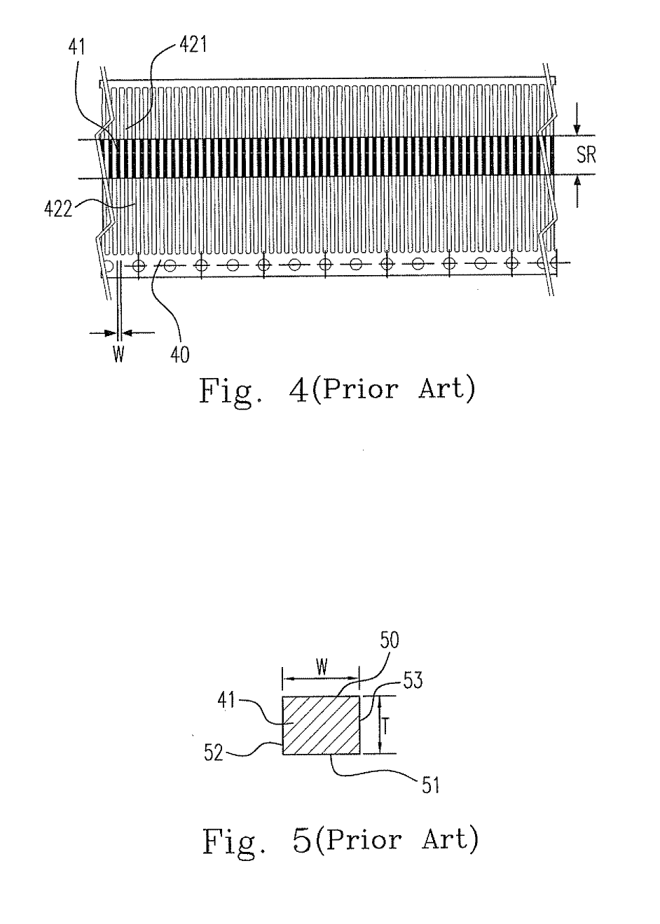

### DETAILED DESCRIPTION OF THE EMBODIMENT

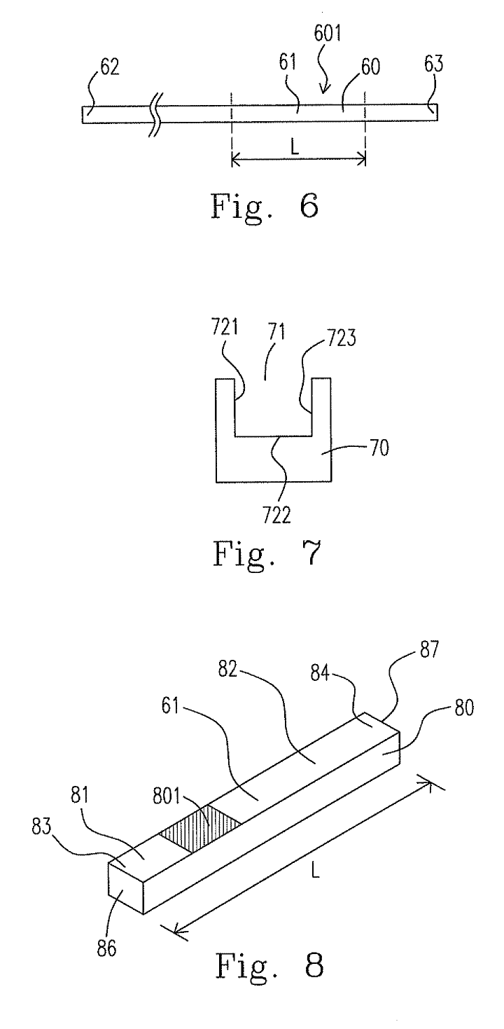

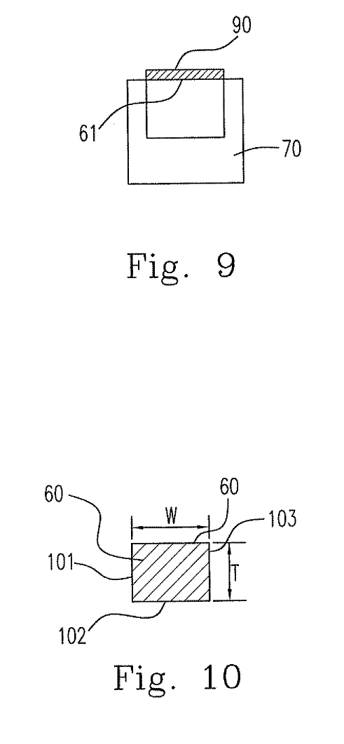

Referring to FIG. 6, which illustrates a material tape 601 of a flat pin 60 for a network jack (not shown). The body of material tape 601 of flat pin 60 has a single surface 61, a front end 62 and a back end 63. The gilding method is to utilize a positioning fixture 70 as shown in FIG. 7, which has a first, a second and a third supporting surfaces 721, 722, 723. First, the body of flat pin 60 is mounted on the gilding position 71 so as to gild on the single surface 61 of flat pin 60. Referring to FIG. 8, material tape 601 of flat pin 60 can be cut into plural flat pins (only one flat pin 80 is shown in Fig.) having a constant length L (e.g. 34.74 mm or other lengths applied to various types of jacks). Single surface 61 further includes a contacting area 801 a first and a second non-contacting area 81, 82, and has a left end 83 and a right end 84. The six surfaces of the body of flat pin 80 include a top surface (i.e. single surface 61), a front-side surface 86 and a back-side surface 87. The gilding method includes steps of plating a metal layer 90 on front end 62, and continuously plating from front end 62 to back end 63 of single surface 61, and completely covering single surface 61. Now the material tape of flat pin 60 is a continuous material tape of flat pin, which is the same continuous material tape with the material tape of round pin 10.

The present invention is also called a method of the “plating single surface of the flat wire by an axial type”, which further includes the steps of: utilizing of a tray-spool 20 (which can be made of any material, for example, a plastic or a paper tray-spool, etc.) to scroll material tape 601 of the flat pin, pulling of the flat pin in the positioning fixture 70 to finish the gilding coat of the single surface 61; and plating on first and second non-contacting area 81, 82 of flat pin 60.

In the viewpoint of another major technique, flat pin 80 of a network jack (not shown in the figures) can be included in the present invention. The network jack includes the body of flat pin 80 and a gilding layer 90 which is completely gilded on a signal surface 61 of the body of flat pin 80. Certainly, signal surface 61 of flat pin 80 belongs to one of the six surfaces of the flat pin. This signal surface 61 is only one surface of a top surface and a bottom surface 85. The body of flat pin 80 can be mounted on positioning fixture 70 to electroplate the gilding layer. Referring to FIG. 10, six surfaces of the body of flat pin 80 further includes a left-side surface 101, a bottom surface 102 and a right-side surface 103, and left, right and bottom surfaces 721, 723, 722 of fixture 70 also have the effect for preventing the downward flow of the plating liquid from the body of the flat pin, i.e. all left-side, right-side and bottom surfaces 101, 103, 102 would be not gilded. Finally, first and second non-contacting areas 81, 82 of flat pin 80 are gilded together with contacting area 801, and the gilding is one type of the plating, the network jack is a connecting device. Front end 62, back end 63, left end 83 and right end 84 are four edges of single surface 61 which is a specific surface. Referring to FIG. 10, the six surfaces of flat pin 80 further include a left-side surface 101, a bottom surface 102 and a right-side surface 103 to be urged against by first, second and third supporting surfaces 721, 722, 723, respectively. Metal layer 90 which has a material of a gold is one type of the conductive layer.

According to one outlook of the main technique, flat pin 80 of the network jack is included in the present invention, which includes the body of flat pin 80, and a gilding layer 90 being located on single surface 60 of the body of flat pin 80 and perfectly covering single surface 61. Certainly, now single surface 61 of flat pin 80 is one of the six surfaces of the body of flat pin 80, this single surface 61 is top surface 61 or bottom surface 102, only one surface of them is necessary to be gilded. The body of flat pin 80 can be mounted into a positioning fixture 70 for plating the gilding layer 90, and contacting area 801 of flat pin 80 is used to contact a network plug (not shown). As to the other details of this embodiment are similar to the above-mentioned, and they are not repeatly illustrated here.

According to another feasible point of view, the present invention is the network jack, which includes a jack body, the body of flat pin 80 mounted into the jack body, and gilding layer 90 being located on single surface 61 of the body of flat pin 80 and perfectly covering single surface 61. Certainly, the other details of this embodiment of the applying network jack of this flat pin 80 are similar to the above-mentioned, and they are not repeatly illustrated here.

The main purposes of the new technique developed by the present invention are as follows:
1. The reduction of the used amount of gold: the gilding amount of round pin 10 is apparently more than flat pin 80 of single surface whole plating of drawing wire, and thus the gilding amount of flat pin 60 is less;
2. The cease of the production of the scrap: there is no scarp generated from flat pin 80 of single surface whole plating of drawing wire, which is better than a large amount of scraps generated from the flat pin 41 of the press selecting plating;
3. The decrease of fabrication cost: the fabrication cost of flat pin 80 of single surface whole plating of drawing wire is awfully lower than that of flat pin 41 of the press selecting plating; and
4. The enhancement the plan of the automatic line: the automatic line of flat pin 80 of single surface whole plating of drawing wire is better than that of flat pin 41 of the press selecting plating.

In conclusion, a novel scheme is provided in the present invention where utilize the plating a metal layer on the front end, then the continuously plating from the front end to the back end all the time on the single surface, and the utilizing of a positioning fixture to gild on the single surface of the flat pin is really able to accomplish the purpose of avoiding the plating on the left side surface and the right side surface.

While the disclosure has been described in terms of what are presently considered to be the most practical and exemplary embodiments, it is to be understood that the disclosure need not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What We claim is:

1. A method for plating a flat pin of a connecting device, the flat pin having four edges and a specific surface, comprising a step of continuously plating a conductive layer all over the specific surface of the flat pin, wherein the specific surface is surrounded by the four edges of the flat pin.

2. A method according to claim 1 further comprising a step of scrolling the plated flat pin by a spool.

3. A method according to claim 1 further comprising a step of positioning the flat pin with a positioning fixture.

4. A method according to claim 3 further comprising a step of pulling the flat pin positioned within the positioning fixture for continuously plating the conductive layer on the specific surface.

5. A method according to claim 3, wherein the positioning fixture has a first, a second and a third supporting surfaces, the flat pin further comprises a left-side, a bottom and a right-side surfaces, and the step of positioning the flat pin is performed via urging against the left-side, the bottom and the right-side surfaces by the first, the second and the third supporting surfaces respectively.

6. A method according to claim 1, wherein the specific surface has a front and a back ends being two opposite ones of the four edges respectively, and the step of continuously plating the conductive layer continuously plates the conductive layer on the specific surface from the frond end to the back end for totally covering the specific surface.

7. A method according to claim 1, wherein the conductive layer has a material of a gold, and the connecting device is a network jack.

8. A flat pin, comprising:
a pin body having four edges defining a specific surface thereamong, and configured in a connecting device; and
a conductive layer totally covering the specific surface.

9. A flat pin according to claim 8, wherein the pin body comprises six surfaces, the specific surface is a top one of the six surfaces of the pin body, and the connecting device is a network jack.

10. A flat pin according to claim 9, wherein the six surfaces are respectively the top surface, a bottom surface, a front-side surface, a back-side surface, a left-side surface and a right-side surface.

11. A flat pin according to claim 8, wherein the flat pin comprises six surfaces, and the specific surface is a bottom one of the six surfaces of the pin body.

12. A flat pin according to claim 8, wherein the specific surface has a contacting area, and a first and a second non-contacting areas.

13. A flat pin according to claim 12, wherein the contacting area contacts an external network plug.

14. A flat pin according to claim 8, wherein the four edges are four straight edges.

15. A network jack, comprising:
a flat pin comprising four edges surrounding a specific surface therein; and
a conductive layer totally covering the specific surface.

16. A network jack according to claim 15, wherein the flat pin has six surfaces of a top surface, a bottom surface, a front-side surface, a back-side surface, a left-side surface and a right-side surface.

17. A network jack according to claim 16, wherein the specific surface is the top surface.

18. A network jack according to claim 16, wherein the specific surface is the bottom surface.

19. A network jack according to claim 15, wherein the specific surface has a contacting area, and a first and a second non-contacting areas, and the contacting area contacts a network plug.

20. A network jack according to claim 15 further comprising a jack body, wherein the flat pin is configured in the jack body.
